(19) United States
(12) Patent Application Publication
(10) Pub. No.: US 2024/0067302 A1
(43) Pub. Date: Feb. 29, 2024

(54) ELECTRIC POWER UNIT AND STRADDLED VEHICLE HAVING THE SAME

(71) Applicant: YAMAHA HATSUDOKI KABUSHIKI KAISHA, Iwata-shi (JP)

(72) Inventor: Yoshinori MATSUOKA, Shizuoka (JP)

(21) Appl. No.: 18/353,189

(22) Filed: Jul. 17, 2023

(30) Foreign Application Priority Data
Aug. 23, 2022 (JP) 2022-132180

(51) Int. Cl. B62M 21/00; B60L 15/20; B62M 7/02; F16D 3/12

(52) U.S. Cl. CPC B62M 21/00; B60L 15/20; B62M 7/02; F16D 3/12; B60L 2200/12; F16D 2300/22

(57) ABSTRACT

An electric power unit includes: an electric motor; a motor shaft disposed in the electric motor; an output shaft that outputs power of the electric power unit; a power transmission mechanism that is connected to the motor shaft and the output shaft and transmits power of the motor shaft to the output shaft; and a torsion damper disposed in the power transmission mechanism.

### CROSS REFERENCE TO RELATED APPLICATIONS

This application claims the benefit of priority to Japanese Patent Application No. 2022-132180 filed on Aug. 23, 2022. The entire contents of this application are incorporated herein by reference.

### BACKGROUND OF THE INVENTION

### Field of the Invention

The present invention relates to an electric power unit and a straddled vehicle having the same.

### Description of the Related Art

Straddled vehicles have been known in the art that have an electric motor as a driving source for driving. Electric motors are easier to control than internal combustion engines. A clutch and a transmission are necessary for a straddled vehicle having an internal combustion engine, whereas a clutch and a transmission can be omitted for a straddled vehicle having an electric motor (hereinafter referred to as an electric vehicle).

However, with an electric vehicle without a clutch and a transmission, there is less of so-called play in the power transmission mechanism from the electric motor to the drive wheel. The driving force of the electric motor is transmitted instantaneously to the drive wheel. Therefore, the rider tends to feel a rigid operating feel. Since it is difficult to apply a large instantaneous force to the drive wheel when starting or accelerating, the rider is less likely to feel the power and the tenacity of driving.

JP 2019-155986A proposes to provide a clutch and an energy-storing rotor in an electric vehicle for the purpose of improving the controllability of the electric vehicle. With this electric vehicle, the provision of the clutch improves the operating feel for the rider. The electric vehicle can store energy by disengaging the clutch and rotating the energy-storing rotor. For example, by engaging the clutch when starting, the energy stored in the energy-storing rotor can be transmitted to the drive wheel in addition to the driving force of the electric motor. Therefore, a large force can be applied to the drive wheel instantaneously.

### SUMMARY OF THE INVENTION

### Technical Problem

With the electric vehicle disclosed in JP 2019-155986A, however, there is a need for a clutch and an energy-storing rotor. This leads to a problem that the electric power unit becomes larger in size.

The present invention has been made in view of the above, and an object thereof is to provide a relatively small electric power unit and a straddled vehicle having the same, with which it is possible to improve the operating feel for the rider.

### Solution to Problem

An electric power unit disclosed herein includes an electric motor having a motor shaft, an output shaft for outputting power, a first power transmission mechanism connected to the motor shaft and the output shaft for transmitting power of the motor shaft to the output shaft, and a damper provided in the first power transmission mechanism.

With the electric power unit described above, since the damper produces play in the first power transmission mechanism, the rider is less likely to feel rigid operating feel. Thus, it is possible to improve the operating feel for the rider. When the rider performs an operation so that the torque of the electric motor increases rapidly when starting or accelerating, part of the energy output by the electric motor is temporarily stored in the damper and then released toward the output shaft. Therefore, even without the energy-storing rotor, it is possible to output a large driving force instantaneously from the output shaft. With the electric power unit described above, there is no need for an energy-storing rotor and a clutch, and it is possible to reduce the size of the electric power unit.

The damper may be a torsion damper including: a first rotor; a second rotor arranged coaxial with the first rotor; and a spring that is interposed between the first rotor and the second rotor and transmits a torque of the first rotor to the second rotor.

Thus, since it is possible to relatively reduce the size of the damper, it is possible to reduce the size of the electric power unit.

The electric power unit may include an idle shaft that is parallel to the motor shaft and/or the output shaft. The first rotor and the second rotor may be supported on the idle shaft.

Thus, as the torsion damper is supported on the idle shaft, which is separate from the motor shaft and the output shaft, the installation of the torsion damper is unlikely to be constrained by the position of the motor shaft and the output shaft. It is possible to increase the degree of freedom in installation of the torsion damper.

The first rotor and the second rotor may be supported on the motor shaft. The first rotor and the second rotor may be supported on the output shaft.

The electric power unit may include a control unit that controls the electric motor so that a torque of the electric motor changes periodically while a steady drive signal is received.

With the electric power unit described above, a damper is provided in the first power transmission mechanism, and the damper has a natural period. If the control unit performs a control so that the fluctuation period of the torque of the electric motor is made to be equal to or closer to the natural period, it is possible to produce resonance. By using the resonance, it is possible to output a large driving force.

The control unit may be configured to control the electric motor so that the fluctuation period of the torque of the electric motor is a predetermined set period based on the natural period of the damper.

Thus, it is possible to make use of resonance, and output a larger driving force from the output shaft.

The electric power unit may include a control unit that, when starting to drive the electric motor, controls the electric motor so as to temporarily generate a torque in a reverse direction and then generate a torque in a forward direction on the electric motor.

Then, as the torque in the reverse direction is temporarily generated on the electric motor, energy is stored in the damper. Then, as the torque in the forward direction is generated on the electric motor, the energy stored in the damper is released in addition to the energy output from the electric motor. Thus, it is possible to instantaneously output a large driving force when starting.

The electric power unit may include a control unit that, when a command to increase a torque of the electric motor is received while the electric motor is running, controls the electric motor so as to temporarily decrease and then increase the torque of the electric motor.

Then, when the torque of the electric motor is temporarily decreased, energy is stored in the damper. Then, as the torque of the electric motor is increased, the energy stored in the damper is released in addition to the energy output from the electric motor. Therefore, it is possible to instantaneously output a large driving force while running.

The electric power unit may include another damper provided in the first power transmission mechanism.

Then, since a plurality of dampers are provided in the first power transmission mechanism, it is possible to further enhance the effects described above.

A straddled vehicle disclosed herein includes: an electric power unit described above; a drive wheel that is driven by power of the electric motor; and a second power transmission mechanism that connects together the output shaft and the drive wheel.

The output shaft may include a connecting portion connected to the second power transmission mechanism. The connecting portion may be arranged on one side in an axial direction of the motor shaft relative to a middle position of the motor shaft in the axial direction; and the damper may be arranged on the other side in the axial direction relative to the middle position of the motor shaft in the axial direction.

The output shaft may include a connecting portion connected to the second power transmission mechanism. The connecting portion and the damper may be arranged on one side in an axial direction of the motor shaft relative to a middle position of the motor shaft in the axial direction.

The straddled vehicle may be an off-road motorcycle.

Off-road motorcycles, as compared to on-road motorcycles, tend to be required to instantaneously output a larger driving force from the electric power unit to the drive wheel when starting or accelerating. Therefore, the effects described above are particularly useful.

### Advantageous Effects of Invention

According to the present invention, it is possible to provide a relatively small electric power unit and a straddled vehicle having the same, with which it is possible to improve the operating feel for the rider.

### BRIEF DESCRIPTION OF THE DRAWINGS

FIG. 1 is a side view of a motorcycle.

FIG. 2 is a cross-sectional view of an electric power unit according to one embodiment.

FIG. 3 is a front view of a torsion damper.

FIG. 4 is a cross-sectional view of an electric power unit according to another embodiment.

FIG. 5 is a cross-sectional view of an electric power unit according to another embodiment.

FIG. 6 is a cross-sectional view of an electric power unit according to another embodiment.

FIG. 7 is a block diagram of a control system for controlling an electric motor.

### DETAILED DESCRIPTION OF THE PREFERRED EMBODIMENTS

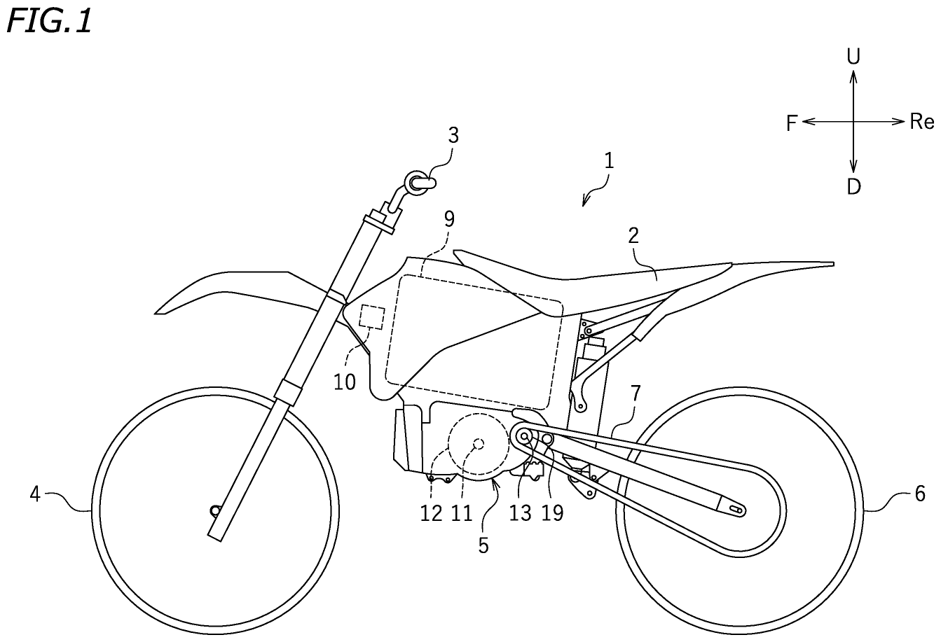

An embodiment will now be described. As shown in FIG. 1, one embodiment of a straddled vehicle to be described below is an off-road motorcycle 1. Herein, the motorcycle 1 is a motocrosser.

The terms front, rear, left, right, up and down, as used in the description below, refer to these directions as viewed from a virtual rider seated on a seat 2 while the motorcycle 1 is standing upright on a horizontal surface with no rider and no load thereon, unless specified otherwise. The designations F, Re, L, R, U and D, as used in the figures, refer to front, rear, left, right, up and down, respectively.

The motorcycle 1 includes a seat 2, a handle 3, an electric power unit 5, a front wheel 4, a rear wheel 6, and a chain 7 linking the electric power unit 5 and the rear wheel 6. The rear wheel 6 is a drive wheel driven by the power of the electric power unit 5. The motorcycle 1 includes a control unit 10 that controls the electric power unit 5.

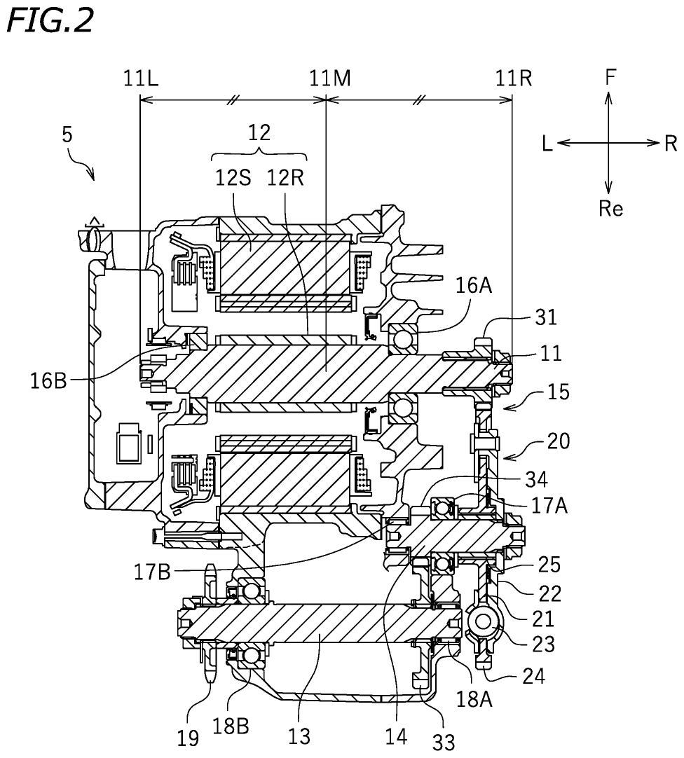

The electric power unit 5 includes an electric motor (hereinafter referred to simply as motor) 12, a motor shaft 11, and a battery 9. FIG. 2 is a cross-sectional view of the electric power unit 5. The electric power unit 5 further includes an output shaft 13 that outputs power, a power transmission mechanism 15 that transmits the power of the motor shaft 11 to the output shaft 13, and a torsion damper 20 provided in the power transmission mechanism 15.

The motor 12 includes a rotor 12R fixed to the motor shaft 11 and a stator 12S arranged around the rotor 12R. In the present embodiment, the motor shaft 11 extends in the left-right direction of the vehicle. The motor shaft 11 is rotatably supported on a bearing 16A and a bearing 16B.

The power transmission mechanism 15 is an example of the “first power transmission mechanism”. In the present embodiment, the power transmission mechanism 15 is a mechanism that transmits power by a plurality of gears. Note however that the power transmission mechanism 15 only needs to be a mechanism that transmits the power of the motor shaft 11 to the output shaft 13, and there is no particular limitation on its specific configuration. The power transmission mechanism 15 is connected to the motor shaft 11 and the output shaft 13. The power transmission mechanism 15 includes a gear 31 fixed to the motor shaft 11, a gear 24 meshing with the gear 31, a torsion damper 20 provided with the gear 24, an idle shaft 14 supporting the torsion damper 20, a gear 34 formed on the idle shaft 14, and a gear 33 meshing with the gear 34. The gear 33 is fixed to the output shaft 13. The idle shaft 14 is rotatably supported on a bearing 17A and a bearing 17B. The idle shaft 14 is arranged parallel to the motor shaft 11. The idle shaft 14 extends in the left-right direction of the vehicle.

The output shaft 13 is rotatably supported on a bearing 18A and a bearing 18B. The output shaft 13 is arranged parallel to the motor shaft 11. The output shaft 13 extends in the left-right direction of the vehicle. The gear 33 is fixed to the right end of the output shaft 13. A sprocket 19 is fixed to the left end of the output shaft 13. A chain 7 (see FIG. 1) is wound around the sprocket 19.

The chain 7 is an example of the “second power transmission mechanism” connecting together the output shaft 13 and the rear wheel 6, which is the drive wheel. Note that the sprocket 19 is an example of the “connecting portion” connected to the second power transmission mechanism of the output shaft 13. The chain 7 transmits the power of the output shaft 13 to the rear wheel 6. Note however that the second power transmission mechanism is not limited to the chain 7. The second power transmission mechanism may include, for example, a transmission belt or a drive shaft.

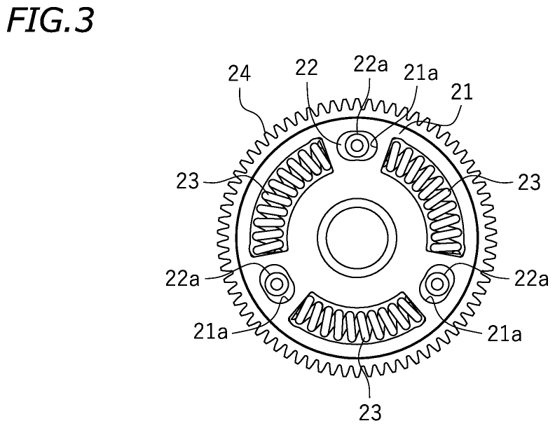

Next, the torsion damper 20 will be described. FIG. 3 is a front view of the torsion damper 20, as viewed from the left side of the motorcycle 1. The torsion damper 20 includes a first rotor 21, a second rotor 22 and a spring 23.

The first rotor 21 and the second rotor 22 are supported on the idle shaft 14. The second rotor 22 is arranged coaxial with the first rotor 21. The idle shaft 14 is provided with a bearing 25, and the first rotor 21 is rotatably supported on the bearing 25. The first rotor 21 is rotatable about the idle shaft 14. The second rotor 22 is not rotatable about the idle shaft 14. The second rotor 22 is configured to rotate together with the idle shaft 14.

The first rotor 21 has a long hole 21a formed therein. The second rotor 22 has a pin 22a inserted into the long hole 21a. The second rotor 22 is rotatable relative to the first rotor 21. As the pin 22a contacts the edge of the long hole 21a, the rotation of the second rotor 22 relative to the first rotor 21 is regulated. The second rotor 22 is rotatable relative to the first rotor 21 until the pin 22a contacts the edge of the long hole 21a. The second rotor 22 is configured to be rotatable relative to the first rotor 21 by a predetermined angle. Note that the number of long holes 21a and pins 22a is 3 in the present embodiment, but there is no particular limitation thereto.

The spring 23 is interposed between the first rotor 21 and the second rotor 22. In other words, the spring 23 is arranged between the first rotor 21 and the second rotor 22 on the path of power transmission. The spring 23 transmits the torque of the first rotor 21 to the second rotor 22. Here, the spring 23 is a coil spring, and the number of springs 23 is 3, but there is no particular limitation on the form and the number of springs 23.

The gear 24 is formed on the first rotor 21. Here, the gear 24 and the first rotor 21 are an integral piece. However, the gear 24 may be formed separately from the first rotor 21.

In FIG. 2, reference sign 11L denotes a straight line that indicates the left end position of the motor shaft 11, and reference sign 11R denotes a straight line that indicates the right end position of the motor shaft 11. Reference sign 11M denotes a straight line that indicates the middle position between the left end and the right end of the motor shaft 11. In other words, reference sign 11M denotes the middle position of the motor shaft 11 in the axial direction. In the present embodiment, the sprocket 19 is arranged on one side in the axial direction relative to the middle position 11M of the motor shaft 11 in the axial direction, and the torsion damper 20 is arranged on the other side in the axial direction relative to the middle position 11M of the motor shaft 11 in the axial direction. Here, the sprocket 19 is arranged leftward relative to the middle position 11M of the motor shaft 11, and the torsion damper 20 is arranged rightward relative to the middle position 11M of the motor shaft 11. Note however that the sprocket 19 may be arranged rightward relative to the middle position 11M of the motor shaft 11, and the torsion damper 20 may be arranged leftward relative to the middle position 11M of the motor shaft 11.

The electric power unit 5 and the motorcycle 1 are configured as described above. Next, the various effects brought about by the electric power unit 5 and the motorcycle 1 will be described.

With the electric power unit 5, the torsion damper 20 is provided in the power transmission mechanism 15 that transmits the power of the motor shaft 11 to the output shaft 13. Since the torsion damper 20 produces play in the power transmission mechanism 15, the rider is less likely to feel a rigid operating feel. Thus, it is possible to improve the operating feel for the rider.

When the rider performs an operation so that the torque of the motor 12 increases rapidly when starting or accelerating, part of the energy output by the motor 12 is temporarily stored in the spring 23 of the torsion damper 20 and then released toward the output shaft 13. With the electric power unit 5, it is possible to output a large driving force instantaneously from the output shaft 13 without separately providing an energy-storing rotor. When the rider performs an operation for rapid start or rapid acceleration, it is possible to make the motorcycle 1 start or accelerate rapidly following the operation. The rider can feel the power and the tenacity of driving of the motorcycle 1 when starting or accelerating. Thus, it is possible to improve the operating feel for the rider. For example, when the motorcycle 1 runs over a step, the impact generated on the rear wheel 6 may be transmitted to the electric power unit 5. According to the present embodiment, the impact transmitted to the output shaft 13 is absorbed by the torsion damper 20. Therefore, it is possible to mitigate the impact applied on the motor 12. It is possible to desirably protect the motor 12 from the impact from the road surface.

With the electric power unit 5, there is no need for an energy-storing rotor and a clutch. Thus, it is possible to reduce the size of the electric power unit 5.

Note that the damper provided in the power transmission mechanism 15 is not limited to the torsion damper 20. Note however that if the torsion damper 20 is used as the damper of the power transmission mechanism 15, it is possible to relatively reduce the size of the damper. Thus, it is possible to reduce the size of the electric power unit 5.

According to the present embodiment, the torsion damper 20 is supported on the idle shaft 14, which is separate from the motor shaft 11 and the output shaft 13. The installation of the torsion damper 20 is unlikely to be constrained by the position of the motor shaft 11 and the output shaft 13. Thus, it is possible to increase the degree of freedom of installation of the torsion damper 20.

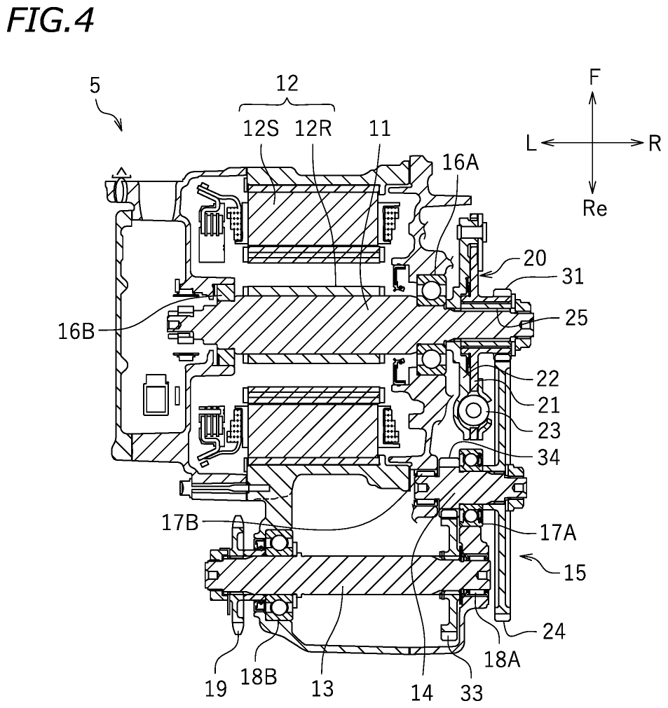

Note however that the torsion damper 20 may be supported on a shaft other than the idle shaft 14. For example, as shown in FIG. 4, the torsion damper 20 may be supported on the motor shaft 11. The first rotor 21 and the second rotor 22 may be supported on the motor shaft 11. In the following description, like elements to those of the embodiment described above will be denoted by like reference signs, and the description thereof will be omitted.

In the embodiment shown in FIG. 4, the bearing 25 is provided on the motor shaft 11 and the first rotor 21 is rotatably supported on the bearing 25. The first rotor 21 is rotatable about the motor shaft 11. The second rotor 22 is configured to be not rotatable about the motor shaft 11 but to rotate together with the motor shaft 11. The gear 31 is provided on first rotor 21. The gear 24 meshing with the gear 31 is supported on the idle shaft 14. The idle shaft 14 rotates together with the gear 24. Otherwise, the configuration is similar to that of the embodiment described above (see FIG. 2).

Also in the embodiment shown in FIG. 4, the torsion damper 20 is provided in the power transmission mechanism 15 that transmits the power of the motor shaft 11 to the output shaft 13. As in the embodiment described above, it is possible to improve the operating feel for the rider, and it is possible to reduce the size of the electric power unit 5.

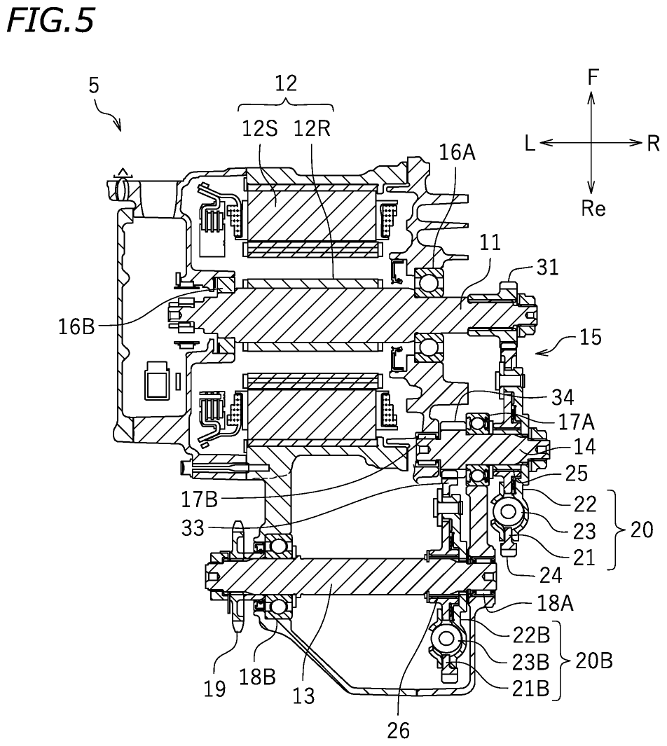

The torsion damper 20 may be supported on the output shaft 13. The number of dampers provided in the power transmission mechanism 15 is not limited to 1. A plurality of dampers may be provided in the power transmission mechanism 15. The embodiment shown in FIG. 5 is an embodiment in which the electric power unit 5 includes the torsion damper 20 supported on the idle shaft 14 and a torsion damper 20B supported on the output shaft 13. In the following description, like elements to those of the embodiment described above will be denoted by like reference signs, and the description thereof will be omitted.

In the embodiment shown in FIG. 5, the torsion damper 20B includes a first rotor 21B and a second rotor 22B supported on the output shaft 13, and a spring 23B interposed between the first rotor 21B and the second rotor 22B. The gear 33 meshing with the gear 34 of the idle shaft 14 is provided on the first rotor 21B. The first rotor 21B rotates together with the idle shaft 14. The first rotor 21B is rotatably supported on a bearing 26 provided on the output shaft 13. The first rotor 21B is rotatable about the output shaft 13. The second rotor 21B is un-rotatably fixed to the output shaft 13. The output shaft 13 rotates together with the second rotor 21B. Otherwise, the configuration is similar to that of the embodiment described above (see FIG. 2).

Also in the embodiment shown in FIG. 5, the torsion damper 20 is provided in the power transmission mechanism 15 that transmits the power of the motor shaft 11 to the output shaft 13. Similar effects to those of the embodiment described above can be obtained. In addition, according to the embodiment shown in FIG. 5, another torsion damper 20B is provided in the power transmission mechanism 15. Therefore, it is possible to further enhance the effects described above.

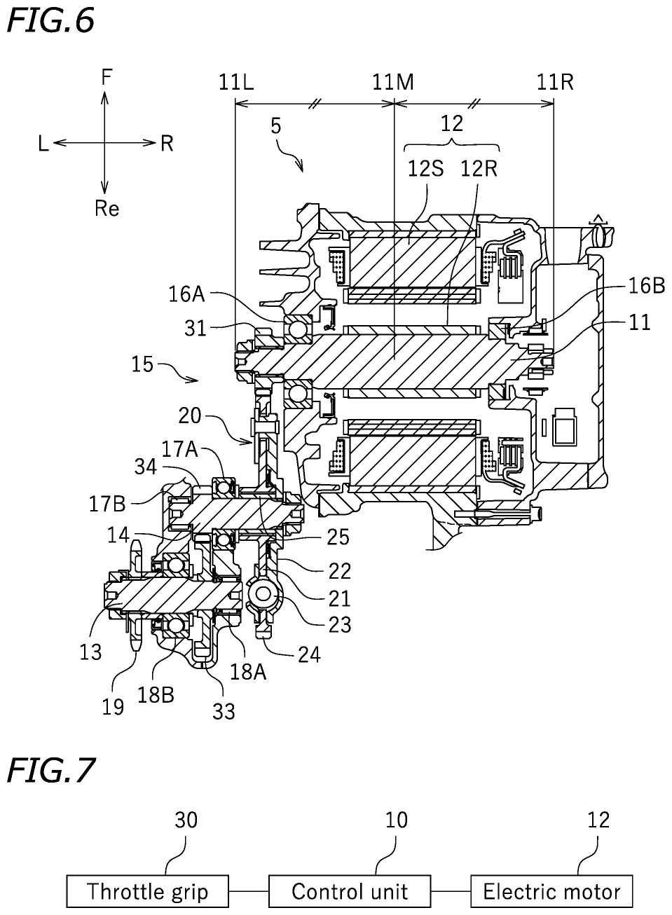

In the embodiment shown in FIG. 2, the sprocket 19 is arranged on one side in the axial direction relative to the middle position 11M of the motor shaft 11 in the axial direction, and the torsion damper 20 is arranged on the other side in the axial direction relative to the middle position 11M of the motor shaft 11 in the axial direction. However, there is no particular limitation on the arrangement of the sprocket 19 and the torsion damper 20. Both of the sprocket 19 and the torsion damper 20 may be arranged on one side in the axial direction relative to the middle position 11M of the motor shaft 11 in the axial direction. For example, as shown in FIG. 6, the sprocket 19 and the torsion damper 20 may be arranged leftward relative to the middle position 11M of the motor shaft 11 in the axial direction. Note that in the embodiment shown in FIG. 6, portions of the power transmission mechanism 15 other than the output shaft 13 are arranged in left-right symmetry with respect to the embodiment shown in FIG. 2.

Although not shown in FIG. 1, the motorcycle 1 includes a throttle grip 30 (see FIG. 7). The throttle grip 30 is an example of the throttle operator to be operated by the rider. The output of the motor 12 is adjusted by the rider operating the throttle grip 30. The control unit 10 is connected to the throttle grip 30 and the motor 12. The control unit 10 receives signals from the throttle grip 30 and controls the motor 12 based on the amount of operation of the throttle grip 30. The control unit 10 is capable of various controls. The following is an example of the control.

When starting to drive the motor 12, the control unit 10 can control the motor 12 so that the motor 12 temporarily generates a torque in the reverse direction and then a torque in the forward direction. For example, when the amount of operation per unit time of the throttle grip 30 becomes equal to or greater than a predetermined threshold value while the motor 12 is not rotating, the control unit 10 first causes the motor 12 to temporarily generate a torque in the reverse direction. This causes elastic deformation of the spring 23 of the torsion damper 20, thereby storing energy in the torsion damper 20. Then, the control unit 10 generates a torque in the forward direction on the motor 12. Thus, the motor 12 starts rotating in the forward direction and the spring 23 restores, thereby releasing the energy stored in the torsion damper 20 (hereinafter referred to as the stored energy). Therefore, the energy of the motor 12 and the stored energy are input to the output shaft 13. An energy that is greater than the energy output by the motor 12 is temporarily input to the output shaft 13. The output shaft 13 can instantaneously output a larger energy. Thus, when the rider suddenly opens the throttle grip 30 wide while the motorcycle 1 is standing, it is possible to rapidly start the motorcycle 1.

When a command to increase the torque of the motor 12 is received while the motor 12 is running, the control unit 10 can control the motor 12 so as to temporarily decrease and then increase the torque of the motor 12. For example, when the amount of operation per unit time of the throttle grip 30 becomes equal to or greater than a predetermined threshold value while the motor 12 is rotating, the control unit 10 first temporarily decreases the torque of the motor 12. For example, the torque of motor 12 is decreased from the first torque to the second torque. This causes elastic deformation of the spring 23 of the torsion damper 20, thereby storing energy in the torsion damper 20. Then, the control unit 10 increases the torque of the motor 12. For example, the torque of the motor 12 is increased from the second torque to the third torque that is greater than the first torque. Then, the torque of the motor 12 increases and the spring 23 restores, thereby releasing the energy stored in the torsion damper 20. The output shaft 13 can instantaneously output a larger energy. Thus, if the rider suddenly opens the throttle grip 30 wide while the motorcycle 1 is running, the motorcycle 1 can accelerate rapidly.

The control unit 10 can control the motor 12 so that the torque of the motor 12 varies periodically. Since the torsion damper 20 includes the spring 23, the torsion damper 20 has a natural period. If the fluctuation period of the torque of the motor 12 is made to be equal to or closer to the natural period of the torsion damper 20, it is possible to produce resonance. By using this resonance, it is possible to output a larger energy from the output shaft 13. For example, when the motorcycle 1 runs at a constant speed, the rider keeps constant the amount of operation of the throttle grip 30. Then, the control unit 10 receives a steady drive signal from the throttle grip 30. The control unit 10 controls the motor 12 so that the torque of the motor 12 changes periodically while a steady drive signal is received. For example, the control unit 10 controls the motor 12 so that the fluctuation period of the torque of the motor 12 is a predetermined set period based on the natural period of the torsion damper 20. Then, it is possible to produce resonance. By using the resonance, it is possible to output a larger driving force from the output shaft 13. A larger driving force can be output from the output shaft 13 without increasing the torque of the motor 12.

Some embodiments have been described above, but the aforementioned embodiments are merely illustrative. Various other embodiments are possible.

While the motor shaft 11, the output shaft 13 and the idle shaft 14 are parallel to each other in the embodiments described above, at least one of them may be non-parallel to at least one other. Where the torsion damper 20 is supported on the motor shaft 11 or the output shaft 13, the idle shaft 14 may be optional.

A straddled vehicle refers to a vehicle that is straddled by the rider. A straddled vehicle is not limited to an off-road motorcycle. A straddled vehicle is not limited to the motorcycle 1. A straddled vehicle may be, for example, an auto tricycle, an ATV (All Terrain Vehicle), or a snowmobile.

The terms and expressions used herein are used for explanation purposes and should not be construed as being restrictive. It should be appreciated that the terms and expressions used herein do not eliminate any equivalents of features illustrated and mentioned herein, but include various modifications falling within the claimed scope of the present invention. The present invention may be embodied in many different forms. The present disclosure is to be considered as providing examples of the principles of the invention. These examples are described herein with the understanding that such examples are not intended to limit the present invention to preferred embodiments described herein and/or illustrated herein. Hence, the present invention is not limited to the preferred embodiments described herein. The present invention includes any and all preferred embodiments including equivalent elements, modifications, omissions, combinations, adaptations and/or alterations as would be appreciated by those skilled in the art on the basis of the present disclosure. The limitations in the claims are to be interpreted broadly based on the language included in the claims and not limited to examples described in the present specification or during the prosecution of the application.

### REFERENCE SIGNS LIST

1: Motorcycle (straddled vehicle), 5: Electric power unit, 6: Rear wheel (drive wheel), 7: Chain (second power transmission mechanism), 10: Control unit, 11: Motor shaft, 12: Electric motor, 13: Output shaft, 14: Idle shaft, 15: Power transmission mechanism (first power transmission mechanism), 19: Sprocket (connecting portion), 20: Torsion damper (damper), 20B: Torsion damper (the other damper), 21: First rotor, 22: Second rotor, 23: Spring

What is claimed is:

1. An electric power unit, comprising:
an electric motor;
a motor shaft disposed in the electric motor;
an output shaft that outputs power of the electric power unit;
a first power transmission mechanism that is connected to the motor shaft and the output shaft, and transmits power of the motor shaft to the output shaft; and
a damper disposed in the first power transmission mechanism.

2. The electric power unit according to claim 1, wherein:
the damper is a torsion damper including:
a first rotor;
a second rotor arranged coaxial with the first rotor; and
a spring that is interposed between the first rotor and the second rotor and transmits a torque of the first rotor to the second rotor.

3. The electric power unit according to claim 2, comprising:
an idle shaft that is parallel to one or both of the motor shaft and the output shaft,
wherein the first rotor and the second rotor are supported on the idle shaft.

4. The electric power unit according to claim 2, wherein the first rotor and the second rotor are supported on the motor shaft.

5. The electric power unit according to claim 2, wherein the first rotor and the second rotor are supported on the output shaft.

6. The electric power unit according to claim 1, further comprising a control unit that controls the electric motor so that a torque of the electric motor changes periodically while a fixed drive signal is received.

7. The electric power unit according to claim 6, wherein
the damper has a natural period; and
the control unit is configured to control the electric motor so that a fluctuation period of the torque of the electric motor is a predetermined set period based on the natural period of the damper.

8. The electric power unit according to claim 1, further comprising a control unit configured to drive the electric motor, and, when starting to drive the electric motor, to control the electric motor so as to temporarily generate a torque in a reverse direction and subsequently generate a torque in a forward direction on the electric motor.

9. The electric power unit according to claim 1, further comprising a control unit that, upon receiving a command to increase a torque of the electric motor while the electric motor is running, controls the electric motor so as to temporarily decrease and subsequently increase the torque of the electric motor.

10. The electric power unit according to claim 1, further comprising another damper provided in the first power transmission mechanism.

11. A straddled vehicle, comprising:
an electric power unit according to claim 1;
a drive wheel that is driven by the power of the electric power unit; and
a second power transmission mechanism that connects the output shaft and the drive wheel.

12. The straddled vehicle according to claim 11, wherein:
the output shaft includes a connecting portion connected to the second power transmission mechanism; and
the connecting portion and the damper are respectively arranged on two different sides of the motor shaft relative to a middle position of the motor shaft in an axial direction of the motor shaft.

13. The straddled vehicle according to claim 11, wherein:
the output shaft includes a connecting portion connected to the second power transmission mechanism; and
the connecting portion and the damper are arranged on a same side of the motor shaft relative to a middle position of the motor shaft in an axial direction of the motor shaft.

14. The straddled vehicle according to claim 11, wherein the straddled vehicle is an off-road motorcycle.
